(19) United States
(12) Patent Application Publication
(10) Pub. No.: US 2021/0006052 A1
(43) Pub. Date: Jan. 7, 2021

(54) ELECTRICAL CONNECTION HANDLE COMPRISING A CABLE GLAND DEVICE

(71) Applicant: MARECHAL ELECTRIC, Saint Maurice (FR)

(72) Inventor: Abdel Mounim HOUIR ALAMI, Paris (FR)

(21) Appl. No.: 16/969,429

(22) PCT Filed: Feb. 12, 2019
(86) PCT No.: PCT/FR2019/050298

§ 371 Date: Aug. 12, 2020

(30) Foreign Application Priority Data
Feb. 15, 2018 (FR) 1851300

(51) Int. Cl. H02G 3/04

(52) U.S. Cl. CPC H02G 3/0456

(57) ABSTRACT

An electrical connection handle comprises a casing having an axial direction, a circumferential direction and a radial direction, a rotary part movable in rotation around the axial direction relative to the casing and coaxial with the casing, and a cable gland device configured to cooperate with an electric cable engaged in the casing and in the rotary part along the axial direction. The cable gland device includes a claw part having a plurality of claws and at least one strip or the like extending along the circumferential direction and configured to clamp radially inwardly the claws of the claw part during the rotation of the rotary part along a first circumferential way.

### TECHNICAL FIELD

The present disclosure relates to an electrical connection handle, the electrical connection possibly being an electrical current plug or an electrical current socket-outlet. More particularly, the present disclosure relates to an electrical connection handle equipped with a cable gland device for mechanically coupling an electric cable to the handle.

### TECHNOLOGICAL BACKGROUND

There are known electrical connection handles equipped with a cable gland device. However, the clamping of the cable gland device of these known handles generally requires the user to provide a significant force for the clamping, and the clamping is obtained after several turns of a clamping nut. This is detrimental to their ease of use. There is therefore a need in this sense.

### PRESENTATION

One embodiment relates to an electrical connection handle comprising a casing having an axial direction, a circumferential direction and a radial direction, a rotary part movable in rotation around the axial direction relative to the casing and coaxial with the casing, and a cable gland device configured to cooperate with an electric cable engaged in the casing and in the rotary part along the axial direction, the cable gland device comprising a claw part comprising a plurality of claws and at least one strip or the like extending along the circumferential direction and configured to clamp radially inwardly the claws of the claw part during the rotation of the rotary part along a first circumferential way.

The handle may form a single and same part with the electrical connection, or form a part separate from the electrical connection, this part being configured to be assembled with the electrical connection. The electrical connection can be a socket-outlet (female portion of an electrical fitting) or a plug (male portion of an electrical fitting).

The axial direction corresponds to the direction of the axis of the casing, parallel to the direction of branching of the electrical connection to assemble it with a complementary connection. The radial direction is a direction perpendicular to the axial direction. The circumferential (or azimuthal) direction corresponds to the direction describing a ring around the axial direction. The three axial, radial and azimuthal directions correspond respectively to the directions defined by the side, the radius and the angle in a cylindrical coordinate system. Unless otherwise specified, the adjectives “internal/inner” and “external/outer” are used with reference to a radial direction so that an internal (i.e. radially internal) portion is closer to the axis of the casing than an external (i.e. radially external) portion.

Within the meaning of the present disclosure, by “strip or the like” is meant any element that can extend along the circumferential direction and that has a length along the axial direction and a length along the radial direction much smaller (for example by a ratio at least 10) than the length along the circumferential direction, such as a strip, a wire, a cable, a blade, etc. and adapted to exert a radial inward clamping force on the claws. Thereafter and unless otherwise indicated, by “strip” is meant “strip or the like”.

The handle may comprise a single strip or a plurality of strips. Thereafter, and unless otherwise indicated, by “the strip” is meant the “at least one strip”.

It is understood that the rotary part is rotatable relative to the casing, which forms the reference part of the handle. In other words, considering that the rotary part rotates relative to the casing, it is considered in return that the casing is fixed relative to the rotary part.

During the rotation of the rotary part, the strip cooperates radially with the claws of the claw part and clamps them, i.e. moves them radially inwardly. The inventors have noticed that such clamping is more direct, and easier for the user. Furthermore, compared to the devices of the state of the art, generally comprising a nut which exerts radial pressure on the claws during an axial displacement, via an inclined bearing plane, for example a frustoconical portion, the strip clamping as proposed by the present disclosure has less friction energy losses. The force that the user must generate, i.e. the torque exerted on the rotary part, is therefore much lower than the one necessary in the devices of the state of the art to obtain a clamping of the claws on an equivalent electric cable. Thus, thanks to the handle according to the present disclosure, the circumferential stroke of the rotary part can be very short (for example a quarter turn), and the clamping force exerted on the electric cable can be very large.

In some embodiments, the strip or the like has a first circumferential end connected to the rotary part and a second circumferential end, opposite to the first circumferential end along the circumferential direction, connected to a base configured to be blocked in rotation along at least the first circumferential way relative to the casing.

In other words, the first circumferential end of the strip is coupled in rotation, at least along the first circumferential way, with the rotary part, while the second circumferential end is coupled to the base which is blocked in rotation along the first circumferential way. This ensures thus a coupling between the rotary part and the strip while one end of the strip is blocked in rotation along the first circumferential way, whereby the strip can be easily tensioned and exert a radial force on the claws. This also has the advantage of reducing the unnecessary stresses (i.e. which are not strictly radial) exerted by the strip on the claw part, and of exerting mainly radial stresses on the claws. The clamping is thus all the more effective while the reliability of the claw part is increased (reduced stresses).

For example, the first end is directly fastened to the rotary part, for example by a pin, a rivet or a screw, while the strip and the base form one and the same part. Such a configuration allows reducing the number of parts, ensures high reliability of the coupling between the base and the strip, while allowing easy assembly between the strip and the rotary part.

For example, the handle comprises only two strips or the like.

In some embodiments, the strip or the like is connected to the base by an arm extending axially.

It is therefore understood that the second circumferential end of each strip is indirectly connected to the base via an arm. This allows axially offsetting the position of the base relative to the position of the strip(s) (the strips may not all have the same axial position), whereby the general space requirement can be optimized.

In some embodiments, the base is coupled in rotation with the claw part.

Such a configuration allows minimizing the friction energy losses during the clamping of the strip between the claws of the claw part and the strip. This also allows facilitating the assembly of the handle, for example by pre-assembling the base with the claw part, before mounting the whole within the casing. For example, this allows blocking only the claw part in rotation within the casing. This can also allow disposing the strip in a predetermined position relative to the claw part, whereby it can be provided that the optional arm and/or the strip cooperates in a particular manner with one or several predetermined claw(s).

In some embodiments, the base is disposed axially between the claw part and the casing, the arm being received in an recess of the claw part so as to cooperate in abutment along the circumferential direction along the first circumferential way and along a second circumferential way, opposite to the first circumferential way, with the claw part.

In other words, the claw part has at least as many recesses as arms, each arm being blocked in rotation, possibly with a clearance, along the circumferential direction, in both ways, by the walls delimiting the recess. Furthermore, the claw part is mounted on the casing by sandwiching the base, which ensures the blocking of the base along the axial direction. Such a structure allows ensuring a simple mounting of the set, while ensuring a reduced space requirement. Such an assembly can also help to dispose the base relative to the claw part and to the casing in a predetermined relative position. By knowing the relative position of the base relative to the casing and that the base is linked to the rotary part (via the arm and the strip), the rotary part also takes a predetermined position relative to the casing during the assembly. This facilitates assembly and disassembly.

In some embodiments, the claw part is configured to be blocked in rotation along at least a first circumferential way relative to the casing, the strip or the like having a first circumferential end connected to the rotary part and a second circumferential end, opposite to the first circumferential end along the circumferential direction, connected to the claw part.

In other words, the first circumferential end of the strip is coupled in rotation, at least along the first circumferential way, with the rotary part, while the second circumferential end is coupled to the claw part which is blocked in rotation along the first circumferential way. This ensures thus a coupling between the rotary part and the strip while one end of the strip is blocked in rotation along the first circumferential way, whereby the strip can be easily tensioned and exert a radial force on the claws.

In some embodiments, the handle comprises only two strips or the like respectively fastened to substantially diametrically opposite claws.

By “substantially diametrically opposite” is meant “diametrically opposite with a tolerance of ±30° (more or less thirty degrees of angle)”.

Such a configuration allows obtaining a good balance between the stresses generated in the claws of the claw part for the retention of the strips, and a uniform and satisfactory clamping on the set of the claws thanks to the two strips mounted diametrically opposite on the claw part.

For example, for assembling the strip with the claw part, the second circumferential end of the strip or the like has an axially extending rod, the rod being engaged axially in a corresponding housing of a claw the claw part. Such a configuration allows easy assembly while ensuring reliable fastening.

For example, the claw(s) on which the strip(s) is/are fastened comprises/comprise a portion extending radially in which the housing is arranged. For example, the casing is a blind or through hole. Such a configuration allows ensuring good resistance of the claw, at the housing, thus forming a robust anchor point for the fastening of the strip.

In some embodiments, the strip or the like has a first circumferential end connected to the rotary part and a second circumferential end, opposite to the first circumferential end along the circumferential direction, connected to the casing.

In other words, the first circumferential end of the strip is coupled in rotation, at least along the first circumferential way, with the rotary part, while the second circumferential end is coupled to the casing, reference part relative to which the rotary part rotates. This ensures a coupling between the rotary part and the strip while one end of the strip is blocked in rotation along the first circumferential way, whereby the strip can be easily tensioned and exert a radial force on the claws. This also has the advantage of reducing the unnecessary stresses (i.e. which are not strictly radial) exerted by the strip on the claw part, and of exerting mainly radial stresses on the claws. The clamping is thus all the more effective while the reliability of the claw part is increased (reduced stresses).

In some embodiments, the handle comprises a single strip or the like having an apertured portion and a solid portion, the solid portion extending through the apertured portion.

The single strip therefore forms a closed loop enclosing the claw part, and more particularly the claws. This allows distributing in a uniform manner the clamping forces over all the claws, while having a reduced part number, which facilitates assembly. For example, the ends of the strip are fastened respectively to the casing and to the rotary part by a pin, a rivet or a screw. Such a single strip allows obtaining a uniform clamping around the entire perimeter of the electric cable.

In some embodiments, the strip or the like cooperates with the claws on a portion disposed between the middle of the claws and the distal end of the claws, the claws being considered along the axial direction.

Such a relative axial position allows the strip to cooperate with the claws on a portion allowing the claws to bend without needing to generate too much force, while remaining at a certain distance from the distal end of the claws to prevent the claws from being released from the strip.

In some embodiments, the claw part comprises a ring carrying the claws, the ring having a thread cooperating with a complementary thread of the casing, the ring being fastened to the casing by screwing along the first circumferential way.

Such an assembly by screwing allows a relatively easy mounting while ensuring a blocking of the claw part in rotation along the first way. This therefore ensures that the claw part is properly blocked in rotation in the first way when the rotary part is rotated in the first way to clamp the strip. In other words, this ensures that the claw part remains stationary relative to the strip and to the rotary part within the casing during the clamping of the strip.

In some embodiments, the handle comprises a back-stop system between the rotary part and the casing configured to authorize the rotation of the rotary part relative to the casing along the first circumferential way and to block the rotation of the rotary part relative to the casing along a second circumferential way opposite to the first circumferential way.

Such a system allows blocking the rotary part in position relative to the casing when the strip is clamped. This ensures permanent clamping of the strip on the claw part. Of course, according to one variant, the back-stop system is unlockable in order to be able to loosen the strip when the user so desires. For example, the back-stop system has teeth and a pawl which is engaged by default with the teeth, the pawl being able to be released from the teeth.

In some embodiments, the handle comprises a seal extending at least partly inside the claw part.

Such a seal allows on the one hand ensuring the sealing of the handle between the claw part and the electric cable clamped by the claws, and on the other hand better distributing the clamping forces exerted by the claws on the cable, thus improving the blocking exerted by the cable gland device.

In some embodiments, the rotary part is snap-fitted along the axial direction with the casing.

Such a mounting is robust and allows facilitating the operations of assembling the handle. Furthermore, such an axial assembly allows minimizing friction along the circumferential direction, whereby the clamping of the strip via the rotary part is easy.

### BRIEF DESCRIPTION OF THE DRAWINGS

The object of the present disclosure and its advantages will be better understood upon reading the detailed description below of different embodiments given by way of non-limiting examples. This description refers to the pages of appended figures, on which:

FIG. 1 represents a first embodiment in a perspective view,

FIG. 2 represents the first embodiment in an exploded and partial cross-sectional view,

FIG. 3 represents the assembled cable gland device of the first embodiment,

FIG. 4 represents a second embodiment in an exploded and partial cross-sectional view,

FIG. 5 represents a third embodiment in an exploded and partial cross-sectional view.

### DETAILED DESCRIPTION

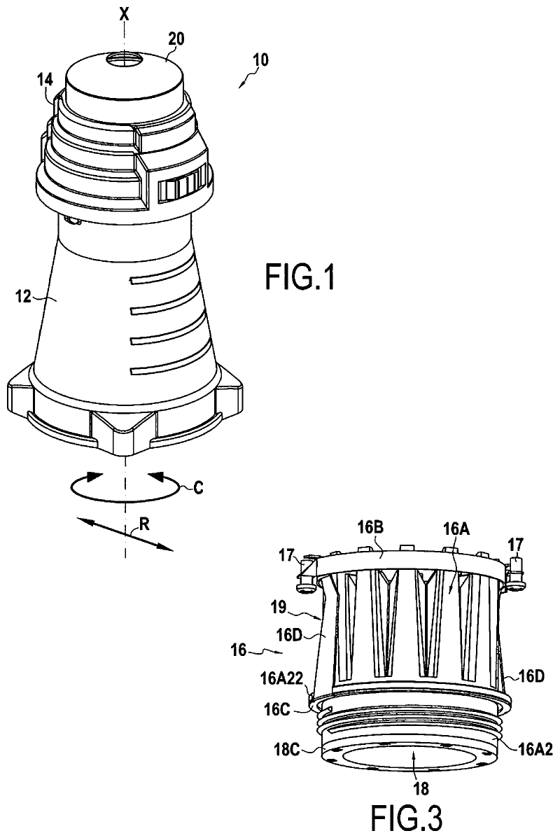

An electrical connection handle 10 according to a first embodiment is described with reference to FIGS. 1, 2 and 3. In this example, the handle is a part separate from a socket-outlet or a plug, and is configured to be mounted on a socket-outlet or a plug (not represented).

The handle 10 comprises a casing 12, a rotary part 14, a cable gland device 16 and a seal 18 received partly in the cable gland device 16. The casing 12 has an axial direction X, a radial direction R and a circumferential direction C. The rotary part 14 is movable in rotation around the axial direction X relative to the casing 12. The casing 12 and the rotary part 14 are mounted coaxially along the axial direction X. It is noted that the rotary part 14 is equipped with a protection 20 configured to cooperate with a cable (not represented) in order to avoid intrusion of dust or liquid along the cable, within the handle 10. In this example, the seal 18 and the protection 20 are made of elastomer (not necessarily the same one) while the rotary part 14 and the casing 12 are made of rigid (compared to the elastomer) plastic (not necessarily the same one).

The cable gland device 16 comprises a claw part 16A and two strips 16B. Of course, according to one variant, there could be a single strip or more than two strips.

The claw part 16A has a plurality of claws 16A1, carried by a ring 16A2. In this example, the claws 16A1 are evenly distributed along the circumferential direction C on the ring 16A2, and extend axially from the ring 16A2, the axis of the ring extending along the axial direction X. The ring 16A2 has on its external periphery a thread 16A21 configured to cooperate by screwing with the complementary thread 12A of the casing 12 for the fastening of the claw part 16 within the casing 12. In this example, the claw part 16A is made of rigid (compared to the elastomer) plastic. However, the claw part 16A is made of less rigid material than the rotary part 14 and the casing 12. For example, the claw part 16A, the rotary part 14 and the casing 12 are manufactured from the same plastic, the plastic of the casing 12 and of the rotary part 14 is additionally filled with glass fibers.

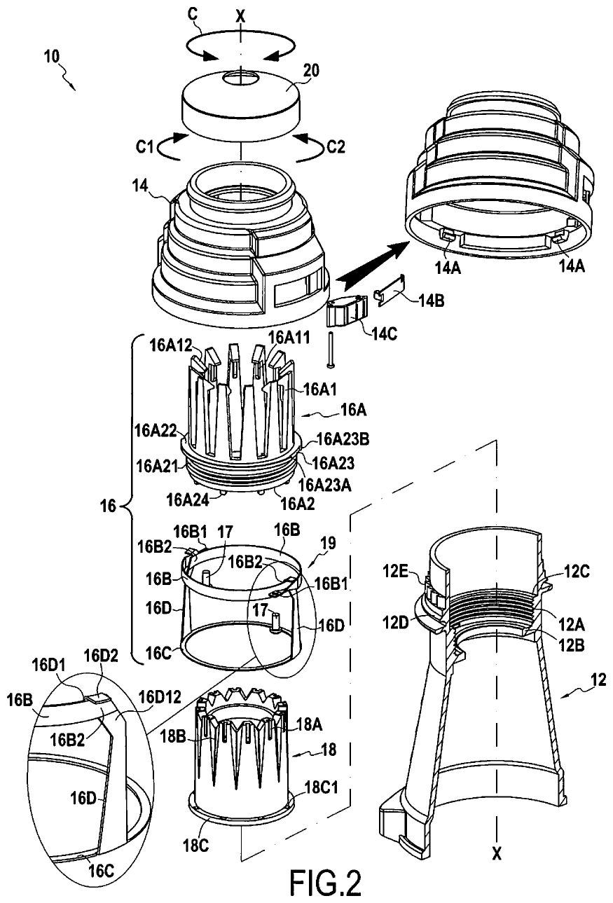

The strips 16B extend along the circumferential direction C, each strip 16B extending partially overlapping along the circumferential direction on an adjacent strip. As can be seen in FIG. 2, the strips 16B cooperate with the claws 16A1 on a portion disposed between the middle and the distal end of the claws 16A1 along the axial direction X, the claws 16A1 being considered along the axial direction X. More specifically, in this example, the strips 16B cooperate with a distal end portion of the claws 16A1, extending from the distal end of the claws. Each strip 16B has a first circumferential end 16B1 fastened to the rotary part 14 by a screw 17 (the thread of the screws 17 not being represented in FIGS. 2 and 3). The second circumferential end 16B2 of each of the strips 16B, opposite to the first circumferential end 16B1 along the circumferential direction C, is fastened to a base 16C via arms 16D. The arms 16D extend along the axial direction X. In this example, the base 16C is unique and carries the two arms 16D which themselves each carry a strip 16B. In this example, the base 16C, the arms 16D and the strips 16B form one and the same part, in this example made of metal (laser-cut and folded sheet metal). Thereafter, and unless otherwise indicated, “strip part” designates the part 19 formed by the base 16C, the arms 16D and the strips 16B.

The axial end 16D1 of each of the arms 16D, opposite along the axial direction, to the base 16D, carries an axial abutment 16D2 extending radially outwardly and configured to cooperate with a strip 16B so as to block the strip 16B along the axial direction in the way opposite to the base 16C. In other words, considered along the axial direction X, the abutment 16D2 is disposed opposite to the strip 16B relative to the base 16C. This abutment 16D2 allows guiding and maintaining the strip 16B during the clamping of this strip 16B. The magnifying glass in FIG. 2 represents this abutment, the arm with which it cooperates not being represented for the sake of clarity. It is understood that the strip 16B with which each abutment 16D2 cooperates is the strip carried by the adjacent arm disposed on the side opposite, along the circumferential direction, to the side where the strip carried by the arm of the considered abutment extends.

The axial end portion 16D12 of each arm 16D, extending over approximately 20% of the axial length of the arm 16D from the axial end 16D1, forms an angle with the rest of the arm 16D. The axial end portion 16D12 is inclined on the side where the strip 16B carried by the considered arm 16D extends, relative to the rest of the arm. This allows reducing friction with the adjacent strip 16B cooperating with the abutment 16D2.

The ring 16A2 has an annular flange 16A22 extending radially outwardly in which two recesses 16A23 are arranged, each recess receiving an arm 16D. The edges 16A23A and 16A23B of each recess 16A23, which are opposite along the circumferential direction C, cooperate in abutment along the circumferential direction with an arm 16D. The edge 16A23A cooperates with an arm 16D along a first circumferential way C1 while the edge 16A23B cooperates with the arm 16D along a second circumferential way C2, opposite to the first circumferential way C1. In this example, the base 16C is coupled in rotation around the axial direction X with the claw part 16A thanks to these recesses 16A23 receiving the arms 16D.

The seal 18 extends inside the claws 16A1, and therefore the claw part 16A and cooperates with the claws 16A1. The claws 16A1 have on their internal wall a rib 16A11 which engages with a groove 18A of the seal, such that the seal 18 remains in position relative to the claw part 16A during the clamping of the claws 16A1 by the strips 16B. Furthermore, the seal 18 has thinned portions 18B to facilitate the radial deformation of the seal 18, and ensure satisfactory cooperation with the cable. The seal 18 has, at its axial end opposite to the end having the grooves 18A, a flange 18C forming a shoulder cooperating axially with the ring 16A2 of the claw part 16A. This flange 18C has reliefs 18C1 evenly distributed along the circumferential direction C configured to cooperate in a form-fitting manner with complementary reliefs 16A24 of the ring 16A2. Thanks to these reliefs, the base of the seal 18 is coupled in rotation with the claw part 16A, which allows maintaining a proper positioning of the seal 18 relative to the claw part 16A during the mounting of the set with the casing 12. Of course, the cooperation of the grooves 18A with the ribs 16A11 also participates in maintaining in position along the circumferential direction of the seal relative to the claw part 16A during the assembly of the set with the casing 12.

To assemble the claw part 16A, the strips 16B and the seal 18 within the casing 12, the seal 18 is placed within the claw part 16A so that the flange 18C cooperates axially with the ring 16A2 of the claw part 16A, and the strip part 19 around the claw part 16A, so that the base 16C cooperates axially with the flange 16A22 of the ring 16A2 and that the arms 16D are housed within recesses 16A23. The flange 18C is disposed opposite to the claws 16A1 along the axial direction X relative to the ring 16A2. The base 16C is disposed opposite to the claws 16A1 along the axial direction relative to the flange 16A22. A set as represented in FIG. 3 is thus obtained. It is noted that the recesses 16A23 allow positioning the strip part 19, and therefore the strips 16B, at a predetermined relative position relative to the claw part 16A. The ends of the strips 16B are then fastened on the rotary part 18, using the screws 17. The claw part 16A is then screwed within the casing 12, along the way C1, until the claw part 16A is blocked in rotation along the way C1 within the casing 12. This blocking can be achieved either by an end of the thread 16A21 and/or 12A, or by cooperation in axial abutment of two complementary shoulders, for example the ring 16A2 against the shoulder 12B of the casing or the flange 16A22 against the shoulder 12C of the casing. Once the set is mounted, the flange 18C1 of the seal 18 is axially sandwiched between (i.e. enclosed by) the shoulder 12B of the casing 12 and the ring 16A2 of the claw part 16A while the base 16C is axially sandwiched between (i.e. enclosed by) the flange 16A22 of the claw part 16A and the shoulder 12C of the casing 12. Thanks to this mounting, the base 16C is blocked in rotation in the way C1 relative to the casing 12, whereby the first ends 16B1 of the strips 16B, connected to the base 16C via the arms 16D, are also blocked in rotation along the way C1. By considering a certain blocking torque for the screwing of the claw part 16A with the casing 12, the base 16C (and therefore the first ends 16B1 of the strips 16B) is also blocked in rotation along the way C2 relative to the casing 12. In addition, the loosening of the claw part 16A relative to the casing 14 is in particular made difficult because of the coefficient of friction of the seal 18 which is sandwiched between the claw part 16A and the casing 14. The clamping way C1 of the strips 16B around the claws 16A1 is the same as the way of assembly of the claw part 16A in the casing 14. Thus, in use, the more a cable tends to be clamped, the more the claw part 16A will be blocked in the casing 14.

It is noted that during this mounting, the rotary part 14 approaches axially the casing 12 so that the tabs 14A of the rotary part engage with the annular rib 12D of the casing 12 and cooperate by axial snap-fitting. This snap-fitting authorizes the rotational movements of the rotary part 14 relative to the casing 12.

It is noted that the rotary part 14 has a blade 14B which engages with the teeth 12E disposed on the periphery of the casing 12 along the circumferential direction C, thus forming a back-stop system blocking the rotational movements of the part rotary 14 in the way C2 but authorizing the movements of the rotary part 14 in the way C1. A lever 14C allows releasing the blade 14A from the teeth 12E, whereby the back-stop system is disengageable, authorizing when it is disengaged, the rotation of the rotary part 14 along the way C2. In this example, the teeth 12E and the blade 14B cooperate radially, but according to one variant (not represented) they could cooperate axially, the blade and the lever being able to be replaced by any type of mechanism also known. It is understood that the lever 14C alternately takes two stable positions, a released position in which it cooperates with the blade 14B so that it is released from the teeth 12E or an engaged position in which it cooperates with the blade 14B so that it is engaged with teeth 12E. The user can thus easily manipulate the rotary part both in clamping and in loosening, by positioning the lever either in engaged position or in released position.

In general, it is understood that the angular accuracy of the clamping obtained thanks to the back-stop system is linked to the number of teeth. Indeed, the more there are teeth 12E, the more the angular space between two adjacent teeth is reduced, thereby allowing reducing the angular pitch of the clamping. Furthermore, the present example comprises a single blade/lever system 14B/14C, but it could of course comprise two or more blade/lever systems. When there are several blade/lever systems 14B/14C, it is also possible, and this in a known manner, to increase the angular accuracy of the clamping by introducing a certain angular deviation or phase shift between the blade/lever systems 14B/14C (i.e. the angular deviation between two adjacent systems 14B/14C is not identical). This allows introducing a certain sequencing of cooperation with the teeth 12E between the systems 14B/14C.

To clamp the cable gland device 16, the rotary part 14 is rotated in the way C1 relative to the casing 12. This drives the second end 16B2 of each strip 16B, which is fastened to the rotary part thanks to the screw 17. The first ends 16B1 of the strips 16B being blocked in rotation by the base 16C via the arms 16D, this rotational movement tensions the strips 16B which thus clamp radially inwardly the claws 16A1 of the claw part 16A. The back-stop system allows blocking the relative circumferential position of the rotary part 14 relative to the casing 12, whereby the pressure on the claws 16A1 exerted by the strips 16B is maintained. The claws 16A1 are thus bent inwardly to cooperate with an electric cable (not represented), and to block it axially relative to the handle 10. The strips 16A being directly connected to the rotary part 14, the clamping is carried out on a very low angle of rotation (less than 45°, even for electric cables of small section), compared to the cable gland devices of the state of the art. To loosen the cable gland device 16, it suffices to actuate the lever 14C to disengage the back-stop system, whereby the rotary part 14 can be rotated in the way C2 and the tension applied to the strips 16B can be released, and therefore the pressure exerted on the claws 16A1.

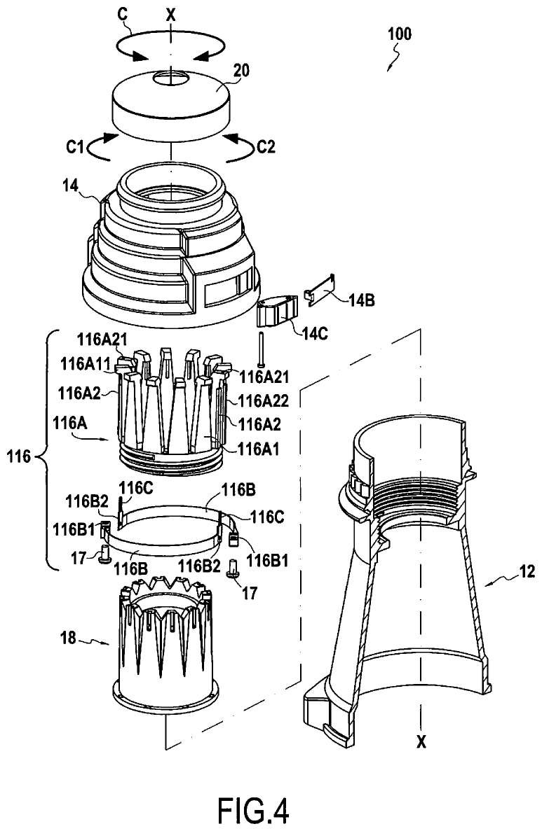

An electrical connection handle 100 according to a second embodiment is described with reference to FIG. 4. This embodiment is identical to the first embodiment, except for the claw part and the strips that have a different structure. The similar elements between the first and the second embodiment are not described again and keep the same reference sign.

The cable gland device 116 of the second embodiment does not have a base or arms, but only a claw part 116A and two strips 116B. Similarly to the first embodiment, each strip 116B partially extends overlapping along the circumferential direction C on an adjacent strip.

Each strip 116B has a first circumferential end 116B1 fastened to the rotary part 14 by a screw 17 (the thread of the screws 17 not being represented in FIG. 4). The second circumferential end 116B2 of each of the strips 116B, opposite to the first circumferential end 116B1 along the circumferential direction C, is fastened to a tooth 116A2 of the claw part 116A. In this example, the cable gland device 116 has only two strips 116B that are respectively fastened to diametrically opposite claws 116A2.

The claws 116A1 and 116A2 each have a portion 116A11 extending radially outwardly from the claw part 116A. In the portions 116A11 of the two claws 116A2, housings 116A21 are arranged, in this example, through-holes extending axially, receiving a rod 116C extending axially from the second circumferential end 116B2 of each strip 116B. Furthermore, the claws 116A2 are equipped with stiffeners 116A22 to improve their bending strength. In this example, the stiffeners 116A22 are formed by a pair of axial ribs. It is noted that the portions 116A11 of the claws 116A1 form axial abutments comparable to the abutments 16D2 of the first embodiment, which cooperate with the strips 116B in order to guide and maintain them during the clamping. The claws 116A2 differ from the claws 116A1 only in that they have a housing 116A21 and stiffeners 116A22.

The assembly and the operation of the handle 100 according to the second embodiment is similar to the assembly and operation of the handle 10 according to the first embodiment, and are therefore not described again, the only difference being that, for the mounting, the strips 116B are first fastened on the claw part 116A, then on the rotary part 14, and then the seal 18 is introduced into the claw part 116A.

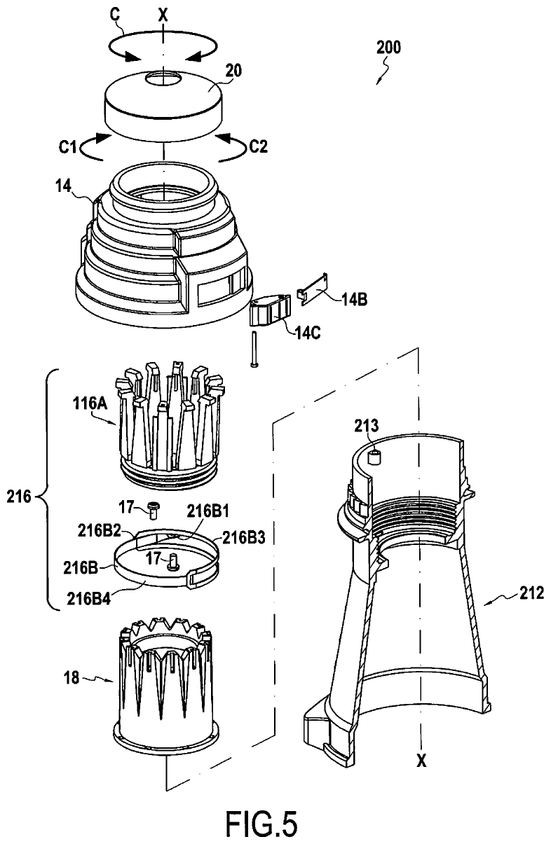

An electrical connection handle 200 according to a third embodiment is described with reference to FIG. 5. This third embodiment is identical to the second embodiment, except for the strips and the casing. The similar elements between the first and second embodiments on the one hand and the third embodiment on the other hand are not described again and keep the same reference sign.

The cable gland device 216 of the third embodiment has the same claw part 116A as that of the second embodiment, and a single strip 216B.

The strip 216B has a first circumferential end 216B1 fastened to the rotary part 14 by a screw 17 (the thread of the screws 17 not being represented in FIG. 5). The second circumferential end 216B2 of the strip 216B, opposite to the first circumferential end 216B1 along the circumferential direction C, is fastened to the casing 212 by a screw 17. It is noted that the casing 212 differs from the casing 12 only in that it has a bore 213 to receive a fastening screw 17.

The strip 216B forms a closed loop along the circumferential direction C and has an apertured portion 216B3 and a solid portion 216B4, the solid portion 216B4 extending through the apertured portion 216B3.

The assembly and the operation of the handle 200 according to the third embodiment is similar to the assembly and the operation of the handles 10 and 100 according to the first and second embodiments, and are therefore not described again.

Although the present invention has been described with reference to specific exemplary embodiments, it is obvious that modifications and changes can be made to these examples without departing from the general scope of the invention as defined by the claims. Particularly, individual characteristics of the various illustrated/mentioned embodiments can be combined in additional embodiments. Consequently, the description and the drawings should be considered in an illustrative rather than restrictive sense.

1.-14. (canceled)

15. An electrical connection handle comprising a casing having an axial direction, a circumferential direction and a radial direction, a rotary part movable in rotation around the axial direction relative to the casing and coaxial with the casing, and a cable gland device configured to cooperate with an electric cable engaged in the casing and in the rotary part along the axial direction, the cable gland device comprising a claw part comprising a plurality of claws and at least one strip or the like extending along the circumferential direction and configured to clamp radially inwardly the claws of the claw part during the rotation of the rotary part along a first circumferential way.

16. The electrical connection handle according to claim 15, wherein the strip or the like has a first circumferential end connected to the rotary part and a second circumferential end, opposite to the first circumferential end along the circumferential direction, connected to a base configured to be blocked in rotation along at least the first circumferential way relative to the casing.

17. The electrical connection handle according to claim 16, wherein the strip or the like is connected to the base by an arm extending axially.

18. The electrical connection handle according to claim 16, wherein the base is coupled in rotation with the claw part.

19. The electrical connection handle according to claim 18, wherein the base is disposed axially between the claw part and the casing, the arm being received in an recess of the claw part so as to cooperate in abutment along the circumferential direction along the first circumferential way and along a second circumferential way, opposite to the first circumferential way, with the claw part.

20. The electrical connection handle according to claim 15, wherein the claw part is configured to be blocked in rotation along at least a first circumferential way relative to the casing, the strip or the like having a first circumferential end connected to the rotary part and a second circumferential end, opposite to the first circumferential end along the circumferential direction, connected to the claw part.

21. The electrical connection handle according to claim 20, comprising only two strips or the like respectively fastened to substantially diametrically opposite claws.

22. The electrical connection handle according to claim 15, wherein the strip or the like has a first circumferential end connected to the rotary part and a second circumferential end, opposite to the first circumferential end along the circumferential direction, connected to the casing.

23. The electrical connection handle according to claim 22, comprising a single strip or the like having an apertured portion and a solid portion, the solid portion extending through the apertured portion.

24. The electrical connection handle according to claim 15, wherein the strip or the like cooperates with the claws on a portion disposed between the middle of the claws and the distal end of the claws, the claws being considered along the axial direction.

25. The electrical connection handle according to claim 15, wherein the claw part comprises a ring carrying the claws, the ring having a thread cooperating with a complementary thread of the casing, the ring being fastened to the casing by screwing along the first circumferential way.

26. The electrical connection handle according to claim 15, comprising a back-stop system between the rotary part and the casing configured to authorize the rotation of the rotary part relative to the casing along the first circumferential way and to block the rotation of the rotary part relative to the casing along a second circumferential way opposite to the first circumferential way.

27. The electrical connection handle according to claim 15, comprising a seal extending at least partly inside the claw part.

28. The electrical connection handle according to claim 15, wherein the rotary part is snap-fitted along the axial direction with the casing.
